(19) United States
(12) Patent Application Publication
(10) Pub. No.: US 2019/0176222 A1
(43) Pub. Date: Jun. 13, 2019

(54) CORE ASSEMBLY FOR CASTING, AND CASTING PROCESS

(71) Applicant: ROLLS-ROYCE plc, London (GB)

(72) Inventor: Aleksander M. CENDROWICZ, Derby (GB)

(73) Assignee: ROLLS-ROYCE plc, London (GB)

(21) Appl. No.: 16/186,632

(22) Filed: Nov. 12, 2018

(30) Foreign Application Priority Data
Dec. 8, 2017 (GB) 1720485.0

(51) Int. Cl. B22C 9/10; F01D 5/18; F01D 5/28

(52) U.S. Cl. CPC B22C 9/103; B22C 9/108; F01D 5/18; F05D 2260/20; F05D 2220/32; F05D 2230/21; F05D 2240/301; F01D 5/28

(57) ABSTRACT

An assembly of core components is provided for investment casting. First core component has an arrangement of pedestals and second core component has an arrangement holes. The first and second core components are assembled to mate in a required positional relationship. Pedestals 106 extend through the holes so that a protruding portion of each pedestal protrudes from the hole. A moulding material is applied to encapsulate the protruding portions of the pedestals to secure the pedestals with respect to the holes and thereby to secure the first core component with respect to the second core component.

### CROSS-REFERENCE TO RELATED APPLICATIONS

This specification is based upon and claims the benefit of priority from UK Patent Application Number GB 1720485.0 filed on Dec. 8, 2017, the entire contents of which are incorporated herein by reference.

### BACKGROUND

### Field of the Disclosure

The present disclosure relates to a method and apparatus for assembling cores in a fixed positional relationship in a shell mould and maintaining this fixed positional relationship in the subsequent casting process for production of a metal casting.

### Description of the Related Art

The investment casting process is used to create metal components, e.g. turbine blades, by introducing molten metal into a ceramic shell of the desired final shape and subsequently removing the ceramic shell.

The process is an evolution of the lost-wax process whereby a component of the size and shape required in metal is manufactured using a wax pattern die into which molten wax is injected and allowed to solidify. The wax pattern is then dipped in ceramic slurry to create a shell on the wax pattern. The wax is removed and the shell fired. The resulting ceramic shell has an open cavity of the size and shape of the final component. Molten metal is introduced into the shell in order to form the component having near net-shape. The ceramic shell is subsequently removed, either or both of physically and chemically.

In order to make a component e.g. an aerofoil blade, with internal cavities e.g. internal cooling channels, a ceramic core is required. This is manufactured separately and is placed inside the wax pattern die prior to wax injection. After casting the metal in the ceramic shell and around the ceramic core, the ceramic core is removed. This can be done by leaching the ceramic core away using alkaline solution, for example, to leave the hollow metal component.

It is important to locate and support the ceramic core in a fixed positional relationship within the ceramic shell in order to accurately control the shape of the hollow metal component after casting.

Ceramic cores may be manufactured via particle injection moulding (PIM). A ceramic material, such as silica, is suspended in an organic binder (vehicle) to create a feedstock. This feedstock is then injected into a die cavity of the required size and shape and allowed to harden to create a “green” component comprising the ceramic and binder components. The binder is subsequently thermally or chemically removed and the ceramic is consolidated by sintering at elevated temperatures; this gives the final ceramic core.

New cooling concepts often require a complex configuration of core passages to give the most efficient level of cooling on the final component. To allow increased complexity of internal cooling passages whilst maintaining manufacturability of the ceramic core, the core can be manufactured in two pieces and assembled together.

In the case where the core is assembled from multiple components, then not only must the positional relationship between the core and the shell be controlled, but also the positional relationship between the component parts of the core must be controlled.

U.S. Pat. No. 5,295,530 discloses the manufacture of a single cast thin wall structure formed using multiple cores. As shown in FIG. 5 of U.S. Pat. No. 5,295,530 (not reproduced here), a first core component is coated with a pattern wax and a second core is placed on top of the pattern wax coating. Pockets are drilled through the second core component into the first core component and rods used to secure the position of the second core component with respect to the first core component. A further pattern wax coating is formed on the second core component and further rods placed in the second core component and protruding from the further pattern wax coating. The casting shell is formed to cover the further pattern wax coating and the protruding rods. When the wax is removed, there remains the second core component suspended between the first core component and the casting shell by the rods. U.S. Pat. No. 5,394,932 discloses a composite core formed from first and second core components which join together via a tongue and groove arrangement.

U.S. Pat. No. 6,186,217 discloses a multi-piece core assembly for creating multi-wall components. The core components fit together by an arrangement of protrusions and recesses forming joints, the joints having an entry hole permitting the introduction of ceramic adhesive through the entry hole into the joint.

U.S. Pat. No. 6,557,621 discloses the assembly of core components by locating protruding members from one component into pockets of another component and using adhesive to hold the components together.

### SUMMARY

The inventor has realised that the prior art approaches to the assembly of core components can be improved. The approaches disclosed in U.S. Pat. No. 6,186,217 and U.S. Pat. No. 6,557,621 are that the joints formed during assembly are likely to be weak and therefore that the cores are at risk of peeling away from each other during the casting process. The tongue and groove approach disclosed in U.S. Pat. No. 5,394,932 is restricted in that this approach does not allow for the assembly of complex components with multiple pedestals. Another difficulty with the approach of U.S. Pat. No. 6,557,621 is that it requires administering a precise dosage of adhesive for gluing the two components together. The approach of U.S. Pat. No. 5,295,530 is extremely time-consuming and therefore expensive, in view of the need to drill holes and place rods through the core components.

Accordingly, there is a need for a method and apparatus for assembling core components that provides an efficient and secure approach to fixing the positional relationship between the core components, ameliorating the problems associated with the prior art approaches discussed above.

In a first aspect, the present disclosure provides a method for manufacturing an assembly of core components for investment casting, the method comprising the steps:

providing a first core component and a second core component, wherein the first core component has an arrangement of either or both of pedestals and holes and the second core component has an arrangement of either or both of holes and pedestals;

assembling the first and second core components to mate in a required positional relationship, wherein the pedestals and holes of the first and second core components correspond to each other to allow the first and second core components to mate in the required positional relationship, the holes extending from a hole entry side to a hole exit side of the respective core component, and wherein the pedestals extend through the holes from the hole entry side to the hole exit side so that a protruding portion of each pedestal protrudes from the hole exit side; and
applying a moulding material to encapsulate the protruding portions of the pedestals extending from the hole exit side with the moulding material to secure the pedestals with respect to the holes and thereby to secure the first core component with respect to the second core component.

In a second aspect, the present disclosure provides an assembly of core components for investment casting, the assembly comprising a first core component and a second core component, wherein the first core component has an arrangement of either or both of pedestals and holes and the second core component has an arrangement of either or both of holes and pedestals, the first and second core components being assembled to mate in a required positional relationship, wherein the pedestals and holes of the first and second core components correspond to each other to allow the first and second core components to mate in the required positional relationship, the holes extending from a hole entry side to a hole exit side of the respective core component, and wherein the pedestals extend through the holes from the hole entry side to the hole exit side so that a protruding portion of each pedestal protrudes from the hole exit side, the assembly further comprising a moulding material applied to encapsulate the protruding portions of the pedestals extending from the hole exit side to secure the pedestals with respect to the holes and thereby to secure the first core component with respect to the second core component.

In a third aspect, there is provided an investment casting process for manufacturing a cast metal component, the process comprising the steps:

providing a shell mould containing an assembly of core components, the assembly of core components comprising a first core component and a second core component, wherein the first core component has an arrangement of either or both of pedestals and holes and the second core component has an arrangement of either or both of holes and pedestals, the first and second core components being assembled to mate in a required positional relationship, wherein the pedestals and holes of the first and second core components correspond to each other to allow the first and second core components to mate in the required positional relationship, the holes extending from a hole entry side to a hole exit side of the respective core component, and wherein the pedestals extend through the holes from the hole entry side to the hole exit side so that a protruding portion of each pedestal protrudes from the hole exit side, the assembly further comprising a moulding material applied to encapsulate the protruding portions of the pedestals extending from the hole exit side to secure the pedestals with respect to the holes and thereby to secure the first core component with respect to the second core component;

introducing a molten metal into the shell mould to fill space between the shell mould and the assembly of core components;

allowing the molten metal to solidify; and

removing the shell mould and the core components.

In a fourth aspect, the present disclosure provides a cast component e.g. a turbine blade or guide vane having an arrangement of either or both of cavities and channels formed by the process of the third aspect.

In a fifth aspect, the present disclosure provides a gas turbine engine having a cast component according to the fourth aspect.

Accordingly, the present disclosure allows core components of complex shape to be assembled efficiently without necessarily requiring precise dosage of adhesive but yet allowing the assembly to have substantial strength to withstand the investment casting process.

Optional features of the present disclosure will now be set out. These are applicable singly or in any combination with any aspect of the present disclosure.

In some embodiments, the investment casting process provides a multi-cavity cast component, such as a gas turbine component. The cavities may be used for cooling during gas turbine operation, e.g. in a ducted fan turbine engine. The pedestals of the core components provide holes in the cast component, these holes linking cavities formed by the core components to allow flow communication of coolant in use, to enhance the cooling efficiency.

In some embodiments, the pedestals are integral with the respective core component from which they extend. In this manner, the pedestals can be formed with the core component via moulding of the entire core component. This provides an efficient approach to the manufacture of accurate shape and positioning of the pedestals on the core component. In some embodiments, however, the pedestals may additionally be machined to shape. This ensures accuracy of shape and dimensions.

Similarly, the holes may be formed via moulding of the entire respective core component. In some embodiments, however, the holes may be machined, which may be additional to or alternative to forming the holes via moulding. Such machining also ensures accuracy of shape and dimensions.

Accuracy of shape and dimensions of the pedestals and holes assists in the reduction of leakage of the moulding material into the gap between the two cores. Furthermore, such accuracy assists in preventing the metal during casting entering a clearance gap between the pedestals and holes.

In some embodiments, one core component, e.g. the first core component, may be provided with the pedestals. Thus, in some embodiments, the other core component, e.g. the second core component, may be provided with the corresponding holes. However, alternatively, it is possible for each core component to be provided with pedestals and holes, for mating engagement with corresponding holes and pedestals of the other core component.

In some embodiments, the second core component may be provided with a cavity into which the holes extend. Thus, when assembled, the respective pedestals of the first core component may extend into the cavity. The cavity may be common to at least some of the holes. In some embodiments, the cavity may be filled with the moulding material. As will be understood, the moulding material ideally remains solid and stable during the investment casting process.

In some embodiments, the pedestals formed on the first component may abut with a surface of the second component in order to define a limit of travel of the pedestals. In this way, the spacing of a gap between the first and second components can be defined. Where the second component has a cavity, the surface of the second component against which the pedestals of the first component abut may be a surface of the cavity.

In some embodiments, the surface of the second component against which the pedestals of the first component abut may be partially or fully machined. This can further improve the accuracy of control of the gap between the first and second components.

In some embodiments, the protruding portions of the pedestals may have an interlock shape to promote engagement with the moulding material. The interlock shape may include at least one re-entrant feature.

In some embodiments, there may be provided additional pedestals on either or both of the first and second core component that do not engage with through holes on the other core component but rather engage with pockets formed on the other core component. These pedestals need not necessarily be secured. They may be provided to further fix the spacing between the assembled core components.

The pedestals may have any suitable cross sectional shape when view along their principal axis, such as circular, elliptical or racetrack cross sectional shape.

In some embodiments, the core components are fired prior to assembly together. In other embodiments, however, the core components may be assembled in an as-moulded condition or in a partially fired condition.

In some embodiments, a core component may be fired or de-binderized or partially fired, then dipped in an inorganic, ceramic-forming liquid. The core component may then be fired, if for example before dipping it was only de-binderized or partially fired. If for example before dipping the core component was fired before dipping, then a further firing process after dipping is optional.

The ceramic forming liquid dip may provide sufficient adhesion between the pedestals and holes to allow the assembled core components to be secured together. In such embodiments, the application of the moulding material to encapsulate the protruding portions of the pedestals may be carried out after assembly and optional firing of the first and second core components. The ceramic forming liquid dip may be, for example, ethyl silicate, colloidal silica, colloidal alumina, colloidal yttria, or any other suitable substance which penetrates the pores of a core component leaving behind a residue which forms a ceramic material during the core firing or casting process.

In some embodiments, the inorganic material of the ceramic-forming liquid comprises particles having an average particle size smaller than the average pore size of the material of the core component. In this case, the assembled core components can be fully immersed in the dip, and then extracted and excess dip from the surface drained.

In some embodiments, the ceramic-forming liquid can provide a coating. Where the inorganic material of the ceramic-forming liquid has an average particle size larger than the average pore size of the material of the core component, the inorganic material substantially does not penetrate into the pores. In this case, where the assembled core components provide an internal cavity, the internal cavity can be selectively coated. In this way, the ceramic-forming liquid can be considered to be an example of a suitable moulding material for encapsulating the protruding portions of the pedestals to secure the first core component to the second core component. The coating can be applied by spraying, painting, or pouring and draining the ceramic-forming liquid, for example.

As mentioned above, in some embodiments, the pedestals formed on the first component may abut with a surface of the second component in order to define a limit of travel of the pedestals. The surface can be coated with an inorganic layer to assist in the securing of the pedestals of the first core component to the second core component. A suitable inorganic layer may be provided with the ceramic forming liquid dip disclosed above.

In some embodiments, the moulding material is formed from a mixture of colloidal and particulate silica and either or both of further optional particulates and organic agents. The moulding material typically sets by drying to form a solid moulding that acts to interlock the two core components. The solidified moulding material may remain stable during the investment casting process, but there may be an acceptable level of sintering that takes place between particles of the moulding material during pre-heat and casting in the casting process.

Where the second core component has a cavity, the cavity may be formed during moulding of the second core component. For example, the cavity may be formed using a chill pin. For example the cavity may be formed using a sacrificial insert which is removed before, during or after firing the second core component. Alternatively, the cavity may be formed by subtractive processing before or after firing the second core component. One example of a subtractive process is CNC machining.

In some embodiments, the first and second core components may be assembled with one or more spacers to define a gap between them. The one or more spacers may be formed of a sacrificial material. For example, the one or more spacers may be chaplets. For example, the one or more spacers may be formed of wax, e.g. as wax sheets.

In some embodiments, a seal element is provided between the first and second core components. The seal element may at least partially cover a gap between at least one of the pedestals and a respective one of the holes at the hole entry side. This has utility for the suppression of leakage of the moulding material through the gap. The seal element may be a sacrificial spacer at least in part defining a gap between the first and second core components.

In some embodiments, either or both of the first and second core components may be formed by an additive manufacturing process. Suitable additive manufacturing processes include ceramic 3D printing and stereo-lithography.

### DESCRIPTION OF THE DRAWINGS

Embodiments of the present disclosure will now be described by way of example with reference to the accompanying drawings in which:

FIG. 1 shows a longitudinal cross-section through a ducted fan gas turbine engine.

FIG. 2 shows a first and second core components for use in an embodiment of the present disclosure, before assembly.

FIG. 3 shows the first and second core components of FIG. 2 during assembly.

FIG. 4 shows the first and second core components of FIG. 2 after assembly.

FIG. 5 shows an alternative embodiment of the present disclosure in partial cross sectional view.

FIG. 6 shows a flow chart of a method according to an embodiment of the present disclosure.

FIG. 7 shows a flow chart of another method according to an embodiment of the present disclosure.

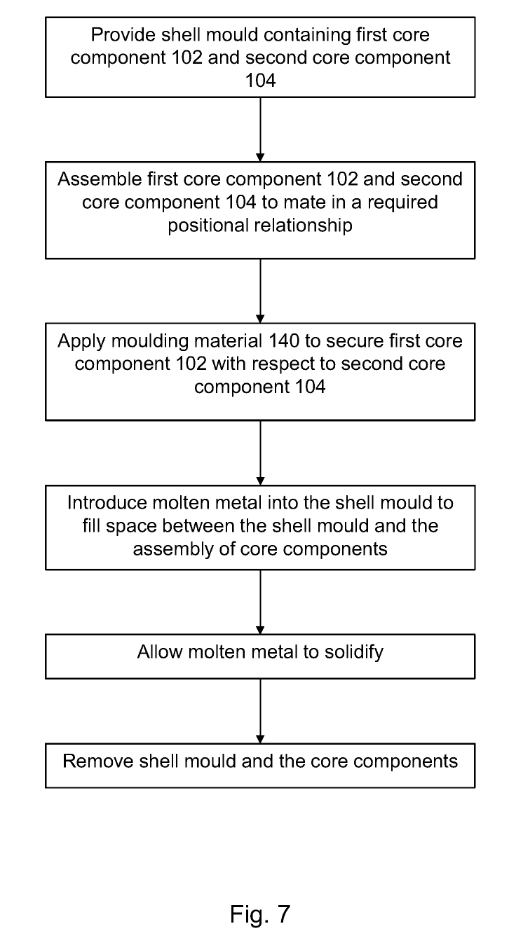

### DETAILED DESCRIPTION

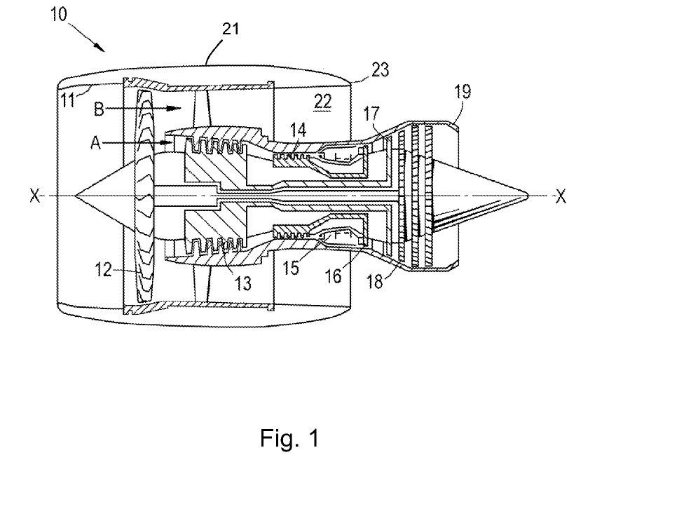

With reference to FIG. 1, a ducted fan gas turbine engine incorporating the features of the present disclosure is generally indicated at 10 and has a principal and rotational axis X-X. The engine comprises, in axial flow series, an air intake 11, a propulsive fan 12, an intermediate pressure compressor 13, a high-pressure compressor 14, combustion equipment 15, a high-pressure turbine 16, an intermediate pressure turbine 17, a low-pressure turbine 18 and a core engine exhaust nozzle 19. A nacelle 21 generally surrounds the engine 10 and defines the intake 11, a bypass duct 22 and a bypass exhaust nozzle 23.

During operation, air entering the intake 11 is accelerated by the fan 12 to produce two air flows: a first air flow A into the intermediate-pressure compressor 13 and a second air flow B which passes through the bypass duct 22 to provide propulsive thrust. The intermediate-pressure compressor 13 compresses the air flow A directed into it before delivering that air to the high-pressure compressor 14 where further compression takes place.

The compressed air exhausted from the high-pressure compressor 14 is directed into the combustion equipment 15 where it is mixed with fuel and the mixture combusted. The resultant hot combustion products then expand through, and thereby drive the high, intermediate and low-pressure turbines 16, 17, 18 before being exhausted through the nozzle 19 to provide additional propulsive thrust. The high, intermediate and low-pressure turbines respectively drive the high and intermediate-pressure compressors 14, 13 and the fan 12 by suitable interconnecting shafts.

The embodiments of the present disclosure relate to the manufacture of cast metal components with complex internal geometries, for example to turbine blades at the high, and either or both of the intermediate and low-pressure turbines 16, 17, 18 in FIG. 1, the turbine blades having interconnected internal cavities to assist with cooling of the blades in use of the engine.

A suitable cast component can be formed according to an embodiment of the present disclosure via investment casting. An assembly of ceramic core components is prepared, this assembly being held in a ceramic shell mould. Molten metal is introduced into the shell mould to fill space between the shell mould and the assembly of core components. The molten metal is allowed to solidify in a known manner to form a desired grain structure for the component (e.g. single crystal or columnar grain structure). The shell mould and the core components are then removed. This can be carried out in a known manner, for example by leaching away the ceramic of the shell mould and core components using a suitable alkaline solution.

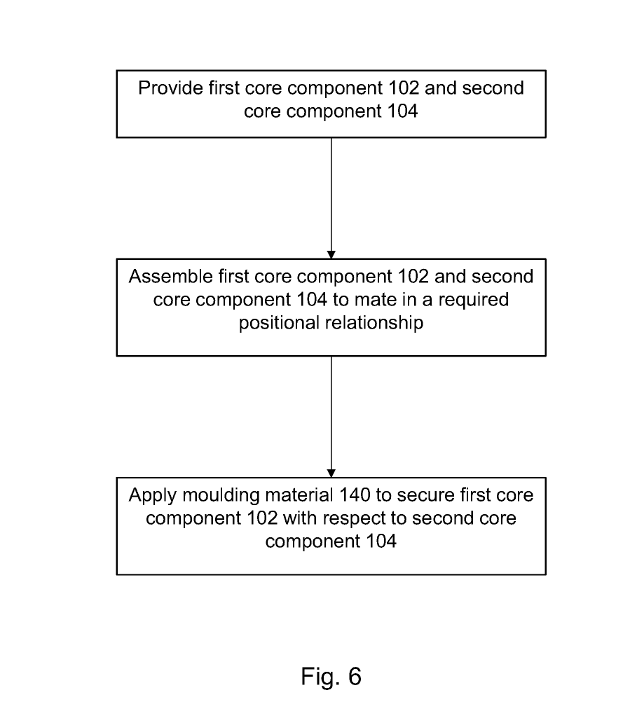

There now follows a more detailed explanation of the assembly of the core components. A broad outline of the method according to an embodiment of the present disclosure is shown in the flowchart of FIG. 6.

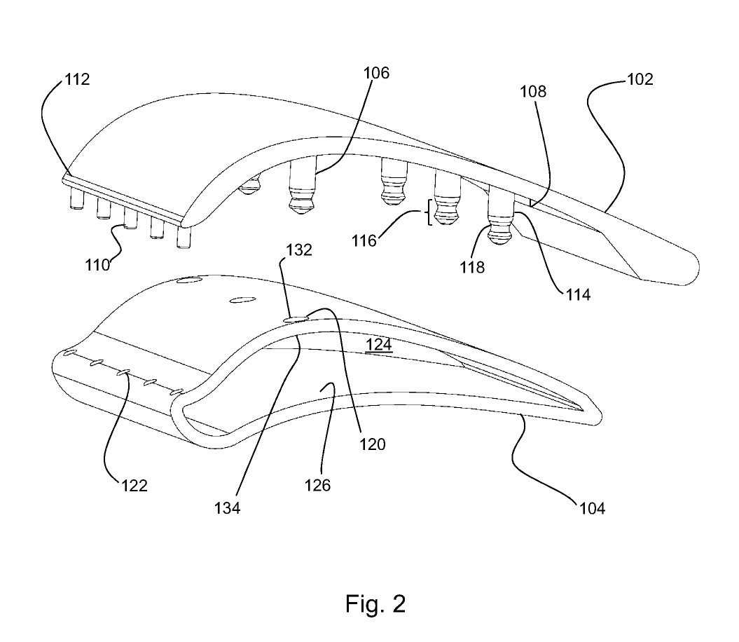

In FIG. 2, first core component 102 and second core component 104 are shown separately, before assembly.

First core component 102 has an array of pedestals 106 extending from one principal surface 108. Additional pedestals 110 are provided also extending from the principle surface 108 but towards the leading edge 112 of the first core component 102. Pedestals 106 have a generally cylindrical trunk portion 114 and a protruding portion 116 with a re-entrant shape 118.

Second core component 104 has a shape generally complementary to the first core component, a space between them (described in more detail below) intended to have a thin aerofoil shape. Second core component 104 has an array of holes 120 intended to receive pedestals 106 and an array of additional holes 122 intended to receive additional pedestals 110.

Second core component 104 has a central cavity 124 defined by internal surface 126.

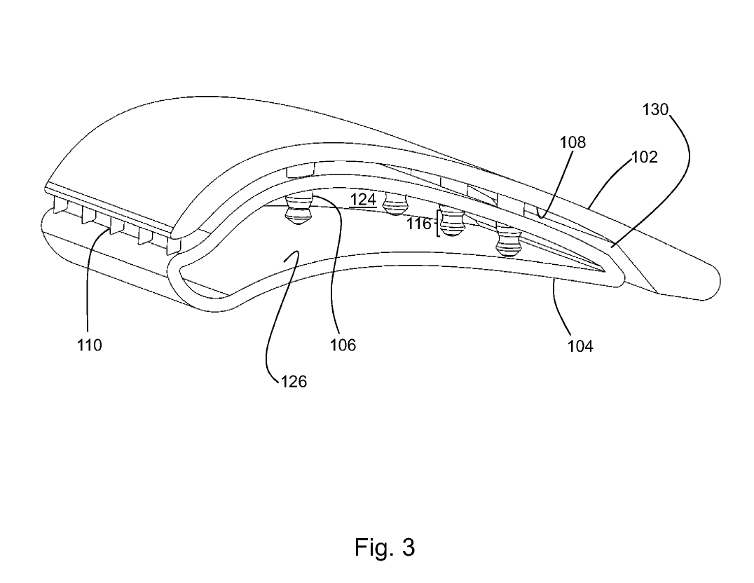

The first 102 and second 104 core component are assembled to mate in the positional relationship illustrated in FIG. 3. The pedestals 106 of the first core component 102 extend through the respective holes 120 of the second core component 104 to protrude into internal cavity 124. Some, but not all, of the pedestals 106 abut against the opposing internal surface 126 of the second core component, thereby limiting the travel of the first core component 102 towards the second core component 104 and thereby defining the extent of the gap 130 between the first core component 102 and the second core component 104. As can be seen in FIG. 3, the protruding part 116 of the pedestals 106 extents into the internal cavity of the second core component 104.

In the second component, the holes 120 have a hole entry side 132 and a hole exit side 134.

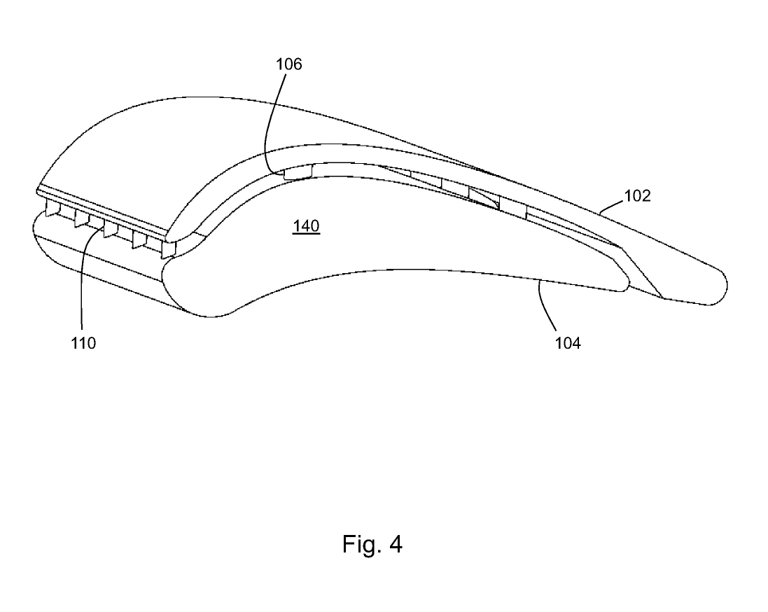

As shown in FIG. 4, a moulding material 140 is applied in order to encapsulate the protruding portions 116 of the pedestals 106 extending from the hole exit side 134 with the moulding material 140 to secure the pedestals 106 with respect to the holes 120. In turn, the first core component 102 is secured with respect to the second core component 104. The moulding material 140 is filled into cavity 124 of the second core component and therefore fills the space around the protruding portion 116 of the pedestals 106, including the re-entrant shape. This provides a particularly secure fixing of the pedestals 106 within the moulding material 140.

The resultant assembly of core components, shown in FIG. 4, can then be used as described above in conjunction with a shell mould (not shown) for investment casting of the metal component having internal interconnected cavities defined by the arrangement of the core components. This approach allows core components of complex shape to be assembled efficiently without necessarily requiring precise dosage of adhesive, because the internal cavity 124 of the second core component 104 can simply be filled with the moulding material, and yet the approach allows the assembly to have substantial strength to withstand the investment casting process.

The pedestals 106 can be formed integrally with the first core component 102, in the sense that they are formed during moulding of the first core component using a suitable mould. Additionally, however, the shape of the pedestals 106 may be finished by machining, in order to ensure precision and accuracy in their shape and dimensions.

The holes 120 may be formed via moulding of the second core component 104. The holes may additionally be finished by machining, in order to ensure accuracy of shape and dimensions.

Accuracy of shape and dimensions of the pedestals 116 and holes 120 assists in the reduction of leakage of the moulding material 140 into the gap 130 between the two core components. Furthermore, such accuracy assists in preventing the metal during casting entering a clearance gap between the pedestals 116 and holes 120.

As can be seen in the illustrated embodiment the first core component 102 is provided with pedestals 116 and the second core component 104 is provided with holes 120. However, in alternative embodiments (not shown), each core component may have an array of pedestals and holes, for engagement with a corresponding array of holes and pedestals in the other core component.

Surface 126 of the second core component 104, being the surface against which the pedestals 116 of the first core component 102 abut may be partially or fully machined. This can further improve the accuracy of control of the gap between the first and second core components.

The core components 102, 104 may be fired prior to assembly together. Alternatively, the core components 102, 104 may be assembled in an as-moulded condition or in a partially fired condition.

It is advantageous in some embodiments for at least one of the core components to be partially fired or de-binderized, then dipped in an inorganic, ceramic-forming liquid and then fully fired. After firing, the ceramic forming liquid may provide sufficient adhesion between the pedestals and holes to allow the assembled core components to be secured together during the firing process. This approach allows the application of the moulding material to encapsulate the protruding portions of the pedestals to be carried out after assembly and firing of the first and second core components.

The ceramic forming liquid dip may be, for example, ethyl silicate, colloidal silica, colloidal alumina, colloidal yttria, or any other suitable substance which penetrates the pores of a core component leaving behind a residue which forms a ceramic material during the core firing or casting process.

Similarly, where the pedestals 106 formed on the first core component 102 abut with surface 126 of the second core component 104 in order to define a limit of travel of the pedestals, surface 126 may be coated with an inorganic layer as described above to assist in the securing of the pedestals of the first core component 102 to the second core component 104.

The moulding material 120 is formed from a mixture of colloidal and particulate silica and either or both of further optional particulates and organic agents. The moulding material sets by drying to form a solid moulding that acts to interlock the two core components 102, 104. The solidified moulding material typically remains stable during the investment casting process.

Cavity 124 in the second core component 104 is formed during moulding of the second core component, although other approaches may be used for forming cavity 124, such as by using a chill pin or sacrificial insert, or by subtractive processing (e.g. CNC machining) before or after firing the second core component.

In some embodiments, either or both of the first 102 and second 104 core components may be formed by an additive manufacturing process. Suitable additive manufacturing processes include ceramic 3D printing and stereo-lithography. As will be understood, it is in principle possible to manufacture a shape corresponding to the assembled core components using advanced additive manufacturing processes. However, it is advantageous to form the first and second core components separately and then assemble them, because this allows for the individual components to be inspected, and defective components removed prior to assembly. Another advantage is that when firing the core components, firing powder may adhere to the surface of the components or may be difficult to remove due to the complex nature of the desired core geometry. Assembly of simpler core components in the fired condition enables the firing powder removal step to be accomplished with less difficulty, and ultimately enables the formation of more complex cooling schemes for the cast metal component.

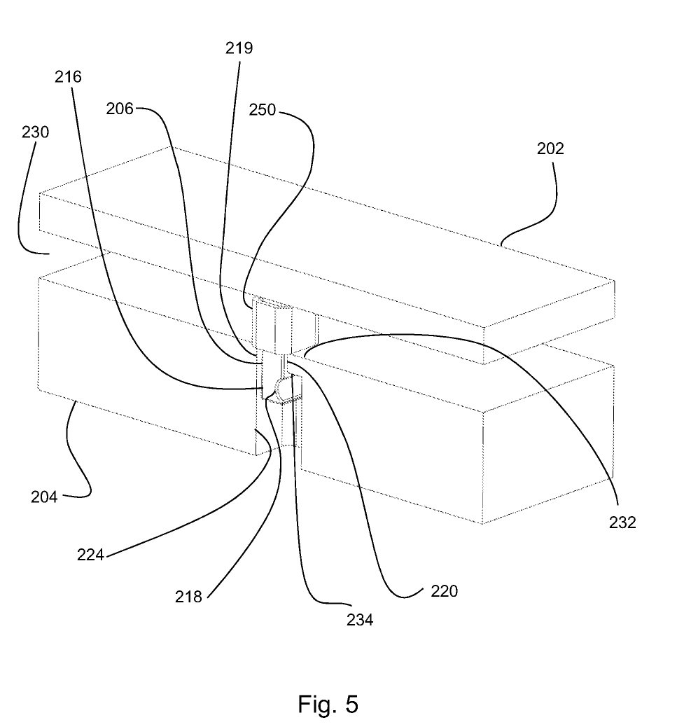

FIG. 5 shows an alternative embodiment of the present disclosure, in schematic partial cross sectional view. First 202 and second 204 core component are assembled to mate in the positional relationship illustrated in FIG. 5. Pedestal 206 (only one is shown, but in further examples, a plurality of pedestals may be provided) of the first core component 202 extend through respective hole 220 of the second core component 204. Hole 220 and pedestal 206 are shown in cross sectional form. As can be seen in FIG. 5, protruding part 216 of the pedestal 206 extents into an internal cavity 224 of the second core component 204.

The travel of the first core component 202 towards the second core component 204 is limited by spacer 250, described in more detail below. This therefore defines the extent of the gap 230 between the first core component 202 and the second core component 204.

In the second component, the hole 220 has a hole entry side 232 and a hole exit side 234.

A moulding material (not shown in FIG. 5) is applied in order to encapsulate the protruding portion 216 of the pedestal 206 extending from the hole exit side 234 with the moulding material to secure the pedestal 206 with respect to the hole 220. In turn, the first core component 202 is secured with respect to the second core component 204. The moulding material is filled into cavity 224 of the second core component and therefore fills the space around the protruding portion 216 of the pedestal 206, including the re-entrant shape 218. This provides a particularly secure fixing of the pedestal 206 within the moulding material.

The spacer 250 is a sacrificial spacer, formed for example from wax. In FIG. 5, spacer 250 is not shown in cross sectional form. The spacer 250 defines the width of the gap 230 between the first and second core components. The spacer can be formed around the pedestal 206 before the first core component is brought to the second core component. Alternatively, the spacer can be formed around the hole 220 at the hole entry side 232 of the second core component. The spacer 250 is therefore provided between the first and second core components and at least partially covering a gap 219 between the pedestal 206 and its respective hole 220 at the hole entry side 232.

The spacer 250 assists in the reduction of leakage of the moulding material into the gap 230 between the two core components.

As mentioned above, the spacer can be fitted on the pedestal or fitted on the second core component. The spacer may be formed by over-moulding directly onto the pedestal or onto the second core component. Alternatively, the spacer can be formed, moulded, machined, or 3d printed separately, and then positioned over the pedestal prior to core assembly, or positioned over the hole prior to core assembly. If it is desired to position the spacer over the hole, the spacer may be provided with additional location features, for examples hooks that extend to the edge of the core component, or links that extend to an adjacent spacer.

In the embodiment described above, the sacrificial spacer may be formed of wax. In other embodiments, the sacrificial spacer may be formed of plastic, resin, rubber or any other organic material which will disappear during the investment casting process either by melting during the wax removal phase, dissolving in the condensed water of a de-wax autoclave, or evaporate or combust during the shell pre-fire before casting.

In the embodiment described above, component 250 is described as a spacer. However, component 250 may be considered to be a seal element. In this case, the seal element need not function to define the limit of the travel of the first core component 202 towards the second core component 204. For example, the seal element may be deformable. The seal element may be formed of rubber, for example. In this case, separate spacers (not shown) may be included to define the limit of the travel of the first core component 202 towards the second core component 204. Therefore, the function of the seal element can be to reduce or prevent the leakage of the moulding material into the gap between the two core components.

While the invention has been described in conjunction with the exemplary embodiments described above, many equivalent modifications and variations will be apparent to those skilled in the art when given this disclosure. Accordingly, the exemplary embodiments of the present disclosure set forth above are considered to be illustrative and not limiting. Various changes to the described embodiments may be made without departing from the spirit and scope of the invention.

All references referred to above are hereby incorporated by reference.

We claim:

1. A method for manufacturing an assembly of core components for investment casting, the method comprising the steps:
providing a first core component and a second core component, wherein the first core component has an arrangement of either or both of pedestals and holes and the second core component has an arrangement of either or both of holes and pedestals;
assembling the first and second core components to mate in a required positional relationship, wherein the pedestals and holes of the first and second core components correspond to each other to allow the first and second core components to mate in the required positional relationship, the holes extending from a hole entry side to a hole exit side of the respective core component, and wherein the pedestals extend through the holes from the hole entry side to the hole exit side so that a protruding portion of each pedestal protrudes from the hole exit side; and
applying a moulding material to encapsulate the protruding portions of the pedestals extending from the hole exit side with the moulding material to secure the pedestals with respect to the holes and thereby to secure the first core component with respect to the second core component.

2. The method as claimed in claim 1 wherein the pedestals are integral with the respective core component from which they extend.

3. The method as claimed in claim 1 wherein the pedestals are machined to shape.

4. The method as claimed in claim 1 wherein the second core component is provided with a cavity into which the holes extend.

5. The method as claimed in claims 1 wherein the pedestals formed on the first core component abut with a surface of the second core component in order to define a limit of travel of the pedestals during assembly of the first and second core components.

6. The method as claimed in claim 1 wherein the protruding portions of the pedestals have an interlock shape to promote engagement with the moulding material.

7. The method as claimed in claim 1 wherein a seal element is provided between the first and second core components and at least partially covering a gap between at least one of the pedestals and a respective one of the holes at the hole entry side.

8. The method as claimed in claim 7 wherein the seal element is a sacrificial spacer at least in part defining a gap between the first and second core components.

9. An assembly of core components for investment casting, the assembly comprising a first core component and a second core component, wherein the first core component has an arrangement of either or both of pedestals and holes and the second core component has an arrangement of either or both of holes and pedestals, the first and second core components being assembled to mate in a required positional relationship, wherein the pedestals and holes of the first and second core components correspond to each other to allow the first and second core components to mate in the required positional relationship, the holes extending from a hole entry side to a hole exit side of the respective core component, and wherein the pedestals extend through the holes from the hole entry side to the hole exit side so that a protruding portion of each pedestal protrudes from the hole exit side, the assembly further comprising a moulding material applied to encapsulate the protruding portions of the pedestals extending from the hole exit side to secure the pedestals with respect to the holes and thereby to secure the first core component with respect to the second core component.

10. The assembly as claimed in claim 9 wherein the pedestals are integral with the respective core component from which they extend.

11. The assembly as claimed in claim 9 wherein the pedestals are machined to shape.

12. The assembly as claimed in claim 9 wherein the second core component is provided with a cavity into which the holes extend.

13. The assembly as claimed in claim 9 wherein the pedestals formed on the first core component abut with a surface of the second core component in order to define a limit of travel of the pedestals during assembly of the first and second core components.

14. The assembly as claimed in claim 9 wherein the protruding portions of the pedestals have an interlock shape to promote engagement with the moulding material.

15. The assembly as claimed in claim 9 wherein a seal element is provided between the first and second core components and at least partially covering a gap between at least one of the pedestals and a respective one of the holes at the hole entry side.

16. An investment casting process for manufacturing a cast metal component, the process comprising the steps:
providing a shell mould containing an assembly of core components, the assembly of core components comprising a first core component and a second core component, wherein the first core component has an arrangement of either or both of pedestals and holes and the second core component has an arrangement of either or both of holes and pedestals, the first and second core components being assembled to mate in a required positional relationship, wherein the pedestals and holes of the first and second core components correspond to each other to allow the first and second core components to mate in the required positional relationship, the holes extending from a hole entry side to a hole exit side of the respective core component, and wherein the pedestals extend through the holes from the hole entry side to the hole exit side so that a protruding portion of each pedestal protrudes from the hole exit side, the assembly further comprising a moulding material applied to encapsulate the protruding portions of the pedestals extending from the hole exit side to secure the pedestals with respect to the holes and thereby to secure the first core component with respect to the second core component;
introducing a molten metal into the shell mould to fill space between the shell mould and the assembly of core components;
allowing the molten metal to solidify; and
removing the shell mould and the core components.

17. A cast component having an arrangement of either or both of cavities and channels formed by the process of claim 16.

18. The cast component as claimed in claim 17 wherein the arrangement of either or both of cavities and channels enables conduction of coolant for cooling the cast component in use.

19. The cast component as claimed in claim 17 wherein the pedestals provide holes in the cast component, said holes linking cavities formed by the core components.

20. The gas turbine engine having a cast component as claimed in any one of claim 17.
